(19) United States
(12) Patent Application Publication
(10) Pub. No.: US 2019/0056128 A1
(43) Pub. Date: Feb. 21, 2019

(54) Multi-Purpose Ceiling Fan with Sensors

(71) Applicant: Emil Jacob, Cambridge, MA (US)

(72) Inventor: Emil Jacob, Cambridge, MA (US)

(21) Appl. No.: 16/107,983

(22) Filed: Aug. 21, 2018

Related U.S. Application Data
(60) Provisional application No. 62/548,137, filed on Aug. 21, 2017.

(51) Int. Cl. F24F 6/16; F04D 19/00; F04D 25/08; F04D 29/58; F04D 29/38; B01D 46/00; B01D 53/26; F24F 3/14; A62C 35/00; A62C 31/28

(52) U.S. Cl. CPC F24F 6/16; F04D 19/002; F04D 25/088; F04D 29/582; F04D 29/388; F24F 2003/144; B01D 53/265; F24F 3/14; A62C 35/00; A62C 31/28; B01D 2279/50; B01D 46/0027

(57) ABSTRACT

A climate control system adapted for a room having a ceiling has a central unit mounted to the ceiling. The central unit has a rotary portion. A plurality of fan blades is carried by the rotary portion. The fan blades are adapted to direct air within the room by rotating clockwise and counter-clockwise. The fan blades have heating elements for producing heated air. The fan blades rotate to push heat downward away from the ceiling. The system has at least one nozzle carried by the central unit for generating mist from the water. The system has at least one sensor for controlling the system. Additional elements can include air purification, air conditioning, and dehumidification. A conduit extends from a central unit to a wall for routing air ducts, a water pipe, a drain tube for draining water, and power.

### CROSS-REFERENCE TO RELATED APPLICATIONS

This patent application claims the benefit of provisional application 62/548,137 filed Aug. 21, 2017, which is incorporated herein by reference.

### TECHNICAL FIELD

The invention described herein relates to systems and methods of conditioning the environment using a multi-purpose fan system. More specifically, the inventions described herein include systems and methods of conditioning interiors, including temperature, humidity, and air purity, as well as serve as fire sprinkler and containing numerous sensors.

### BACKGROUND

In conventional housing environment conditioning state systems, there is generally a central unit located in a basement or utility closet and piping or duct work that is routed to the entire house to condition the various rooms. Another unit that is becoming more common in the United States is the split system unit in which an interior unit has air passed by a coil to condition the air while conducting tubing is run from this unit to a second coil unit outside the house. The pressure and temperature of the system can be used to either draw heat from the outside to heat the house or expel heat to the outside to cool the house.

Traditional systems that use oil and gas or electrically-powered central air units require large ducts to bring the warm or cold air to each room, loosing energy along the way—such as from basements through a building or a house. The installation of ducts for HVAC systems requires extensive labor, particularly in homes without HVAC systems.

### SUMMARY

It is recognized that a unit, a climate control system or universal ceiling fan that has all of the components for maintaining the climate of a room all in one unit that is compact and an efficient manner is desired.

The invention reduces the electrical energy needed to heat a space by using heated ceiling fans to spread heat more evenly and quickly, and to move the warmest air downwards from the upper area of the room where the rising heat stagnates, as a more efficient mode than traditional electrical heating such as pumps, heated boards, and others. For further efficiency, the invention includes a sensor that reduces or deactivates heating or cooling when no one is in a room.

One of the goals of the invention is to provide a means for adding cooling and heating systems in a room without requiring the extensive installation of the traditional HVAC system.

In an embodiment, a climate control system adapted for a room having a ceiling, the climate control system includes a central unit mounted to the ceiling. The central unit has a rotary portion. A plurality of fan blades is carried by the rotary portion. The fan blades are adapted to direct air within the room by rotating clockwise and counter-clockwise. The climate control system has a water line to deliver water to the central unit. The system has at least one nozzle carried by the central unit for generating mist from the water.

In an embodiment, the fan blades of the system each have a heating element for producing heated air. The fan blades rotate to push heated air downward away from the ceiling.

In an embodiment, an air conditioning unit is carried by the central unit of the system. The system has a conduit extending from the central unit to a wall for routing at least one duct from the central unit for exhausting warm air from the air conditioning unit and a drain tube for draining water.

In an embodiment, a dehumidifier unit carried by the central unit of the system. The system has a conduit extending from the central unit to a wall for routing a drain tube for draining water.

In an embodiment, the system has an air purifier having a filter and an air exchange. The system has a conduit extending from the central unit to a wall for routing at least one duct from the central unit for air exchange.

In an embodiment, the system has at least one sensor for monitoring room air quality. In an embodiment, the sensor includes a fire sensor, a heat sensor, a smoke detection sensor, a temperature sensor, a humidity sensor, and an air quality sensor.

In an embodiment, the system has a dehumidifier unit carried by the central unit. The system has a conduit extending from the central unit to a wall for routing a drain tube for draining water.

In an embodiment, the system has a fire sensor wherein the nozzle can be used for fire suppression.

In an embodiment, a climate control system adapted for a room having a ceiling, the climate control system includes a central unit mounted to the ceiling. The central unit has a rotary portion. A plurality of fan blades is carried by the rotary portion. The fan blades are adapted to direct air within the room by rotating clockwise and counter-clockwise. At least one of the fan blades has a heating element for producing heated air and the fan blades rotate for pushing heat downward away from the ceiling.

In an embodiment, the climate control system has a dehumidifier unit carried by the central unit. The system has a conduit extending from the central unit to a wall for routing a drain tube for draining water.

In an embodiment, the dehumidifier has coils on the fan blades for dehumidifying the air as the fan blades rotate. In an embodiment, the fan blades have at least one flap that opens up to create more surface area.

In an embodiment, the system has an air purifier having a filter and an air exchange. The system has a conduit extending from the central unit to a wall for routing at least one duct from the central unit for air exchange. In an embodiment, the fan rotates to direct air as desired by the air purifier unit.

In an embodiment, the system has a circular coil heat element underlying the circular unit.

### BRIEF DESCRIPTION OF THE SEVERAL VIEWS OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a perspective view from below of a climate control system according to the invention;

FIG. 2 is a schematic of a prime mechanical unit;

FIG. 3 is a perspective view from a side of the climate control system;

FIG. 4 is a schematic sectional view of the central unit;

FIG. 5 is a perspective view from a side of the climate control system with a door open showing access to a conditioning unit;

FIG. 6 is a perspective view from the side of the climate control system of FIG. 5 showing misting from the fan blade;

FIG. 7 is a view from outside of the house showing the room through a window and an air interface port of the climate control system;

FIG. 8A is a sectional view of the conduit from the central unit;

FIG. 8B is a sectional view of an alternative conduit from the central unit;

FIG. 9 is a schematic view of the conduit extending from the outside to the prime mechanical unit;

FIG. 10 is a perspective view from below of an alternative embodiment of the climate control system with a circular heat element underlying the central unit; and

FIG. 11 is a schematic of sensor interaction

### DETAILED DESCRIPTION

A climate control system adapted for a room having a ceiling has a central unit mounted to the ceiling. The central unit has a rotary portion. A plurality of fan blades is carried by the rotary portion. The fan blades are adapted to direct air within the room by rotating clockwise and counter-clockwise. The fan blades have heating elements for producing heated air. The fan blades rotate to push heat downward away from the ceiling. The climate control system has a water line to deliver water to the central unit. The system has at least one nozzle carried by the central unit for generating mist from the water. The system has at least one sensor for controlling the system. Additional elements can include air purification, air conditioning, and dehumidification. A conduit extends from a central unit to a wall for routing air ducts, a water pipe, a drain tube for draining water.

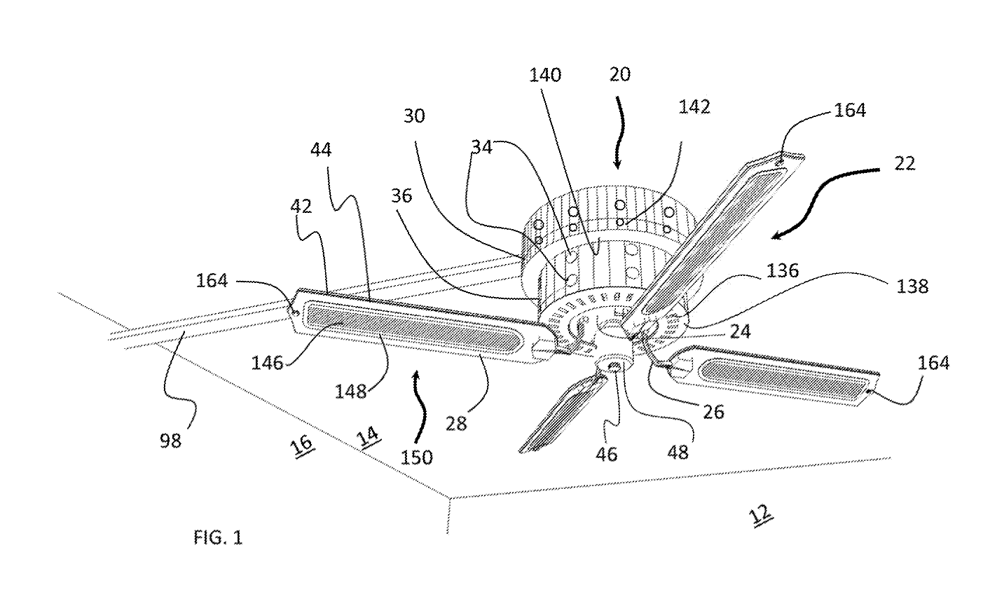

Referring to FIG. 1, a climate control system 20 having a central unit 22 with a rotary portion 24 with arms 26 each for retaining a fan blade 28 is shown. The climate control system 20 is shown in a room 12 with a ceiling 14 and a series of walls 16.

The climate control system 20 has a large cylindrical portion 30 that overlies the central unit 22. The climate control system 20 has a prime mechanical unit 50, as described below, located in the large cylindrical portion 30. The central unit 22 has a plurality of small openings 34 on the cylindrical portion 36 of the smaller central unit 22.

The climate control system 20 in addition has a metal element 42 on the edge 44 or rim of at least one fan blade 28. The metal element 42 is heated to generate heat which is transferred to the air and thus the room. As explained below, the climate control system 20 has a transfer mechanism for transferring electricity, air, and water to the rotating fan blades 28.

In addition, the climate control system 20 has a sensor unit 46 with a plurality of sensors such as the temperature sensor 48. The control of the heating of the metal element 42 is done per an algorithm with data collected from a sensor unit 46 that has a temperature sensor 48.

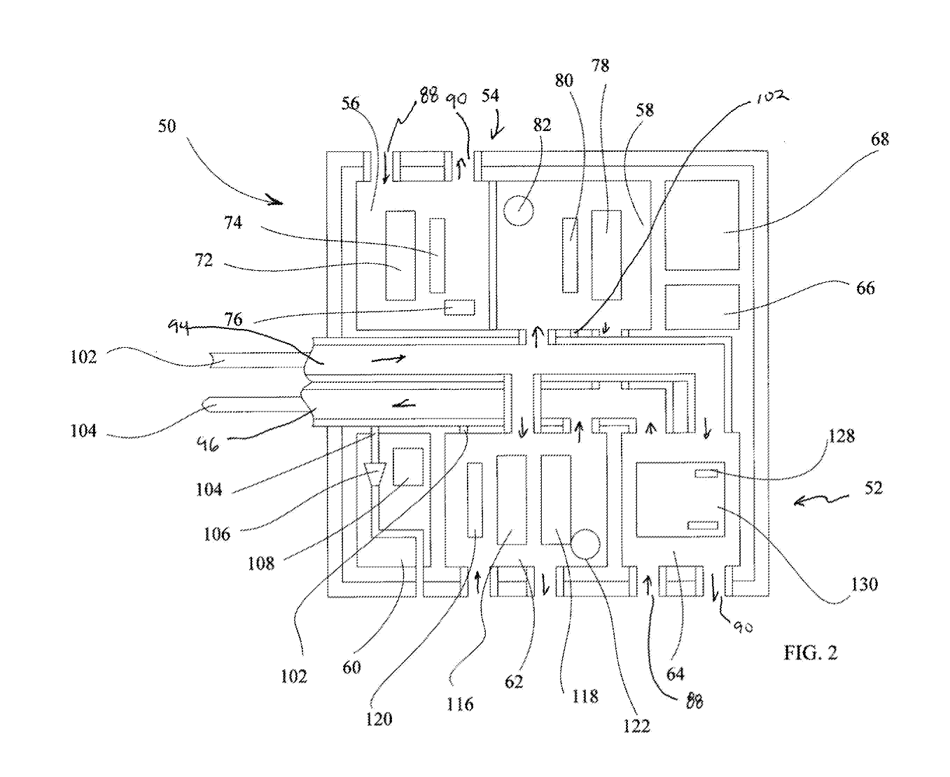

Referring to FIG. 2, a schematic of the prime mechanical unit 50 is shown. The prime mechanical unit 50 has various mechanical component units 52 such as an air conditioning unit 54 having two compartments referred to as an inside portion compartment 56 and an outside portion compartment 58. In addition, the prime mechanical unit 52 has a humidifier unit 60, a dehumidifier unit 62, and an air purifier unit 64. In addition, the prime mechanical unit 50 has additional components including a power unit 66 and a central process unit 68 that interacts with each of the units 52 and the sensor unit 46, shown in FIG. 1, and other units.

The air conditioning unit 54 has an evaporator coil 72, an evaporator fan 74, and an expansion device 76 in the inside portion 56. The air conditioning unit has a condensing coil 78, a condensing fan 80, and a compressor 82 in the outside portion. The inside portion 56 has an air intake 88 which draws air from the room 12 via a plurality of openings 136 and 142, such as in FIG. 1, and an air exhaust or return 90 for transferring “cool” air to the room via the small openings 34. While not shown in this embodiment, the air conditioning unit 54 can also have an air exchange with the outside 18.

The outside portion compartment 58 of the air conditioning unit 54 has an air intake 94 from the outside and an air exhaust 96 which exhausts the hot humid air to the outside 18 of the house. The air intake 94 and the air exhaust 96 are connected to the outside through a conduit 98. In addition, the outside portion 58 of the air conditioning unit 54 has a connection to a drain tube 102 that moves water out of the outside portion 58. The drain tube 102 extends through the conduit 98 to a household drain. It is recognized that the drain tube 102 could also extend to outside 18 of the house. The drain tube 102 has a pump for moving the water from the prime mechanical unit 50.

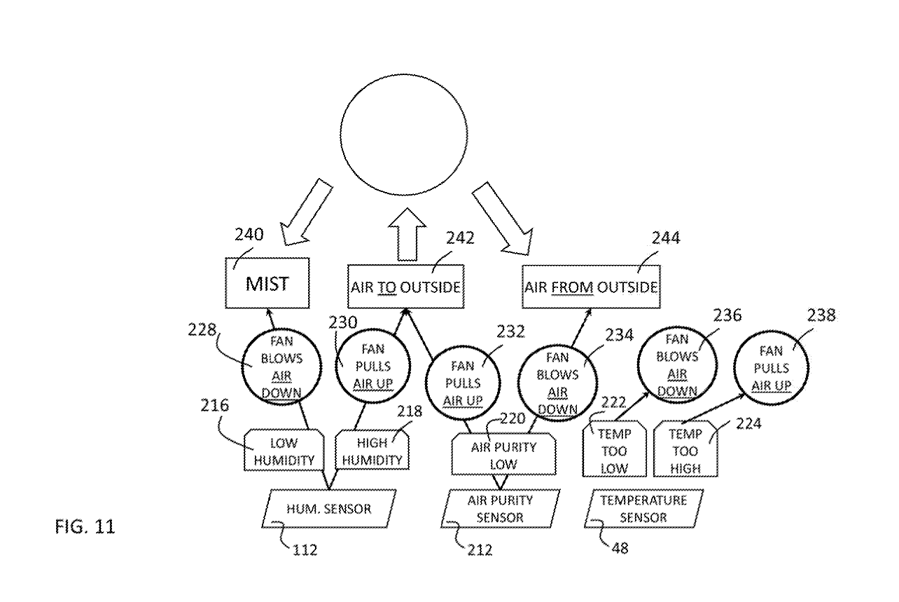

The humidifier unit 60 has a water input 104, which receives the water from the house plumbing through the conduit 98. The humidifier unit 60 has a valve 106 that is controlled by a processor 108. The processor 108 is connected to a humidity sensor 112, such as represented in FIG. 11 on the sensor unit 46.

The dehumidifier unit 62 has a cooling coil 116 that is used to extract the moisture as a liquid when the air passes over the coils. The air is then passed over a heating coil 118. The dehumidifier unit 62 has a fan 120 to move the air over the coils 116 and 118. The dehumidifier unit 62 in addition, similar to the air condition unit 54, has a compressor 122 and an expansion device 124.

The dehumidifier unit 62 has connection to the room 12, via the air intake 88 and the air exhaust 90, and the outside 18, via the air intake 94 and the air exhaust 96. Generally when the dehumidifier unit 62 is running, the connection only to the room 12 is open; the connection to the outside 18 is closed.

The air purifier unit 64 has a filter system 128. In addition, the air purifier unit 64 has a heat exchanger 130 to adjust the temperature of any air brought in from the outside to closer to the room 12 (e.g., raise the temperature of air from outside in the winter by gathering heat from the air that is being exhausted from room 12 via pulling air from air intake 88 of the room and pushed out the air exhaust 96 to the outside 18.)

It is recognized that various components can be combined completely or in part. For example, the air conditioning unit 54 and the dehumidifier unit 62 are shown separately, the components could be combined to both reduce weight and cost. Potentially the valving and circuitry would become more complex.

For clarity, not all of the components and interface are shown. For example, not all of the pumps, valves, and fans associated with the prime mechanical unit 50 are shown.

Referring back to FIG. 1, in addition to the rotary portion 24 projecting from the bottom of the central unit 22, the central unit has a plurality of openings 136 on the bottom surface 138 of the central unit 22; the bottom surface 138 encircles the rotary portion 24. The climate control system 20 has a plurality of openings 142 near the lower edge 140 of the large cylindrical portion 30.

The air conditioning unit 54 draws air from the room 12 via the openings 136 and 142 into the air intake 88. The conditioned air is returned to the room 12 via the small openings 34 via the air exhaust 90 from the air conditioning unit 54. While cold air sinks, the fan blades 28 in addition move the air around the room 12.

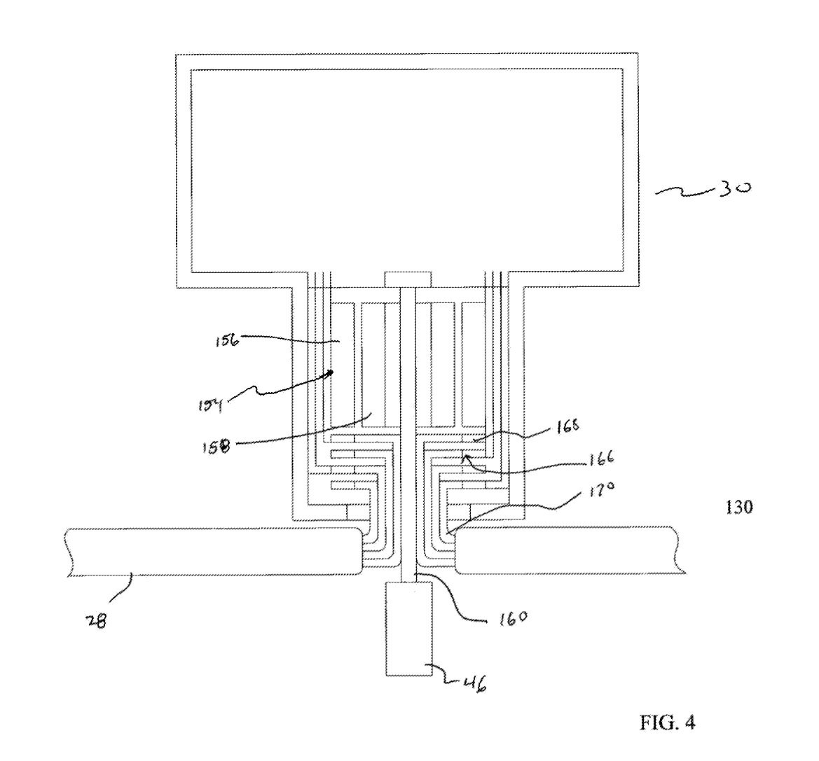

The dehumidifier system 150 of the climate control system 20 has an area 146 on at least one of the fan blades 28 with a plurality of openings 148 on the surface. The openings 148 allow air with moisture to pass by an evaporator coil; the movement of the fan blades 28 is in place of a fan such as in the prime mechanical unit 50. The moisture is collected and drawn back to the prime mechanical unit 50 as explained in part with respect to FIG. 4.

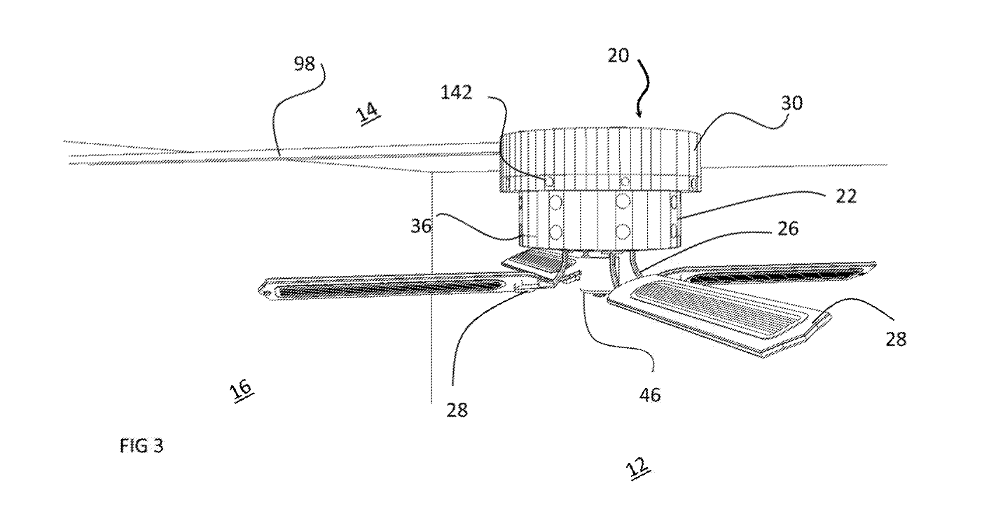

Referring to FIG. 3, a perspective view from a side of the climate control system is shown. The fan blades 28 are each held by an arm 26 to the rotary portion 24 of the central unit 22. The arms 26, in addition to retaining the fan blades 28, are used to communicate various items such as power and water to the fan blades 28. The climate control system 20 is shown mounted to the ceiling 14 of a room 12.

The large cylindrical portion 30 of the climate control system 20 overlies the central unit 22. The central unit 22 has the plurality of small openings 34 on the cylindrical portion 36 of the smaller central unit 22. The conduit 98 extends from the central unit 22 to the wall 16 along the ceiling 14 of the room 10.

Referring to FIG. 4, a schematic sectional view of the central unit 22 is shown. The climate control system 20 has a motor 154 in the central unit 22 with a stator 156 and a rotor 158 for rotating the fan blades 28. The system 20 has a rotating shaft 160 to support the fan blades 28.

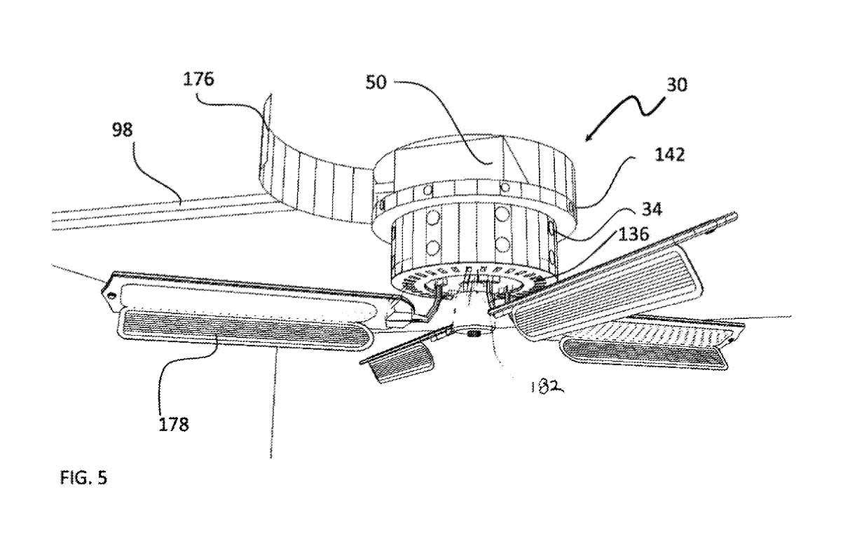

As indicated above, the fan blades 28 have certain elements such as the metal element 42 that require power. In addition, the fan blades 28 can provide misting such as shown in FIG. 5 or a temperature sensor 164 such as shown in FIG. 1. The climate control system 20 has a connector interface 166 with a plurality of stator connectors 168, located below the stator 156, that interface with a plurality of rotor connectors 170 which rotate with the rotor 158 and the fan blades 28. The type of connector is dependent on if the connection is needed for power, data signal, water, or other fluid. It is recognized that the seals would be required may differ depending on the type of fluid, liquid, or gas.

Referring back to FIG. 1, the dehumidifier system 150 on the fan blade 28 required the compressed coolant to be transferred the connector interface 166 between the rotor connector 170 and the stator connector 168 associated with the prime mechanical unit 50. Likewise the water that is collected is drawn back through another of the connector interface 166 to the drain tube 102.

Referring to FIG. 5, a perspective view from a side of the climate control system 20 with a door 176 open showing access the prime mechanical unit 50 is shown. The mechanical components units 52 can be replaced if necessary with minimum effort. Dependent on the individual unit, the connections can be quick connections or pins.

The fan blades 28 of the climate control system 20 are shown in an absorbing position where a flap 88 flips from the fan blade 28 is shown. The climate control system 20 moves the flap 88 to the absorbing position when the humidity sensor 112 reads humidity above a certain level. The open flap method captures more air than drawing into the central unit 22 or the fan blades 28 shown in FIG. 1.

In an alternative, the fan blades 28 of the climate control system 20 can be rotated initially to pull the humid or stale air up. The flap 88 on each fan blade 28 are then open to better ingest the air. The flap 88 is then closed and the process is repeated.

Still referring to FIG. 5, if the humidity sensor 112 reads humidity below a programmed level, it activates the humidifier unit 60 of the climate control system 20 which generates a mist 182 which exits the central unit 22 via the openings 136.

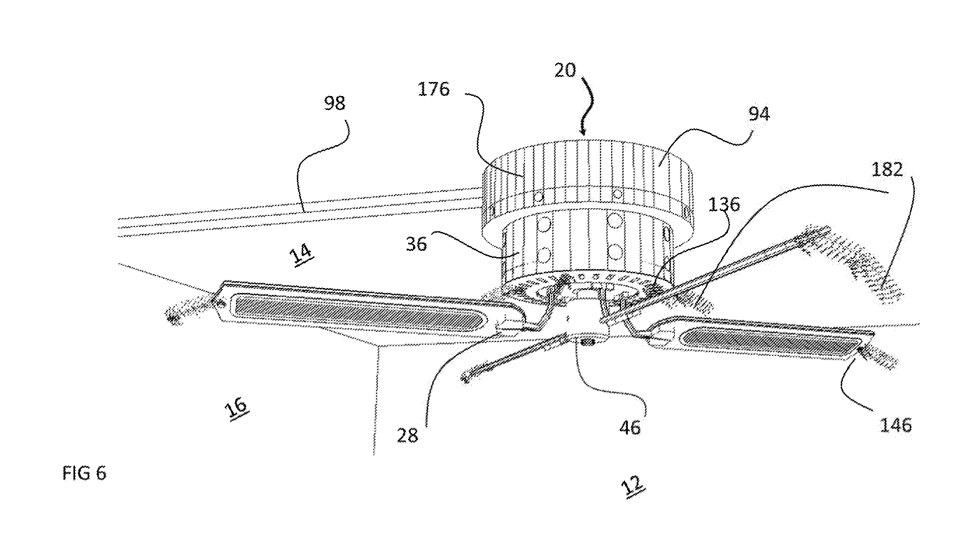

Referring to FIG. 6, the embodiment of the climate control system 20 with the large cylindrical portion of FIG. 5 with the door 94 closed is shown. In addition to the openings 136 for generate the mist 182 such as shown in FIG. 5, the climate control system 20 has ducting for water to the end of the fan blades 28 to a mist port 186 so that the mist 182 can also be released via the blades 28. The direction of the mist can be tailored in various directions including the mist can be sprayed towards the blades or away from the blades from the tip end of the blades 28.

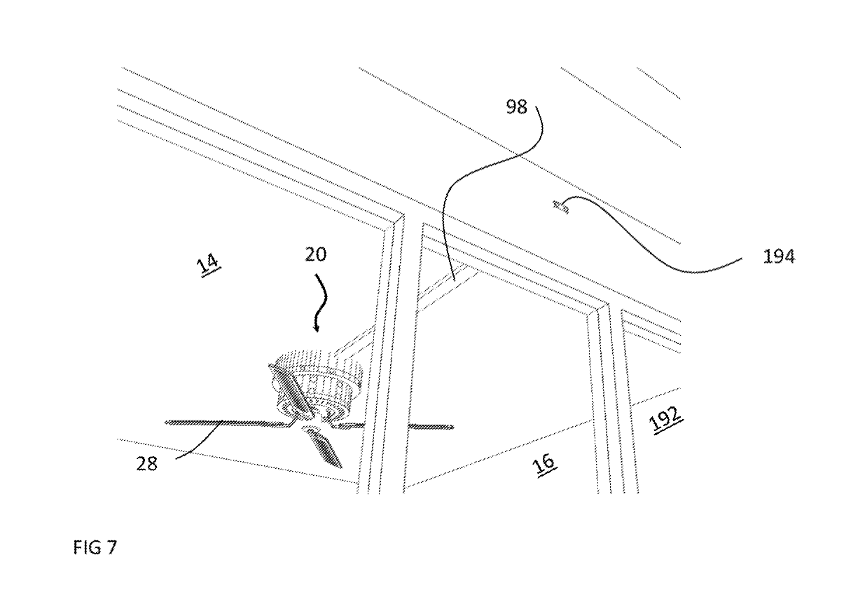

Referring to FIG. 7, a view from outside 18 of the house showing the room 12 through a window 192 and an air interface port 194 of the climate control system 20 is shown. The air interface port 194 has a pair of duct ports 196 and 198. One of the ports 196 is connected to the air intake 94 and the other port 198 is connected to the air exhaust 96 of the prime mechanical unit 50. The air intake duct 94 and the air exhaust duct 96 run in the conduit 98 on the ceiling 14 of the room 12. The air intake duct 94 is used to pull fresh air to the prime mechanical unit 50. The other, the air exhaust duct 96 is used to remove stale air, or warm air created by the air-conditioning unit 54 shown in FIG. 2.

In one embodiment, the algorithm is designs to wait at least three minutes from removing stale air before bringing in fresh air in order to avoid brining in the same air. The intake and the outtake fans never work at the same time. Alternatively, a single duct can be sufficient as it only needs to work in one direction at any given time.

In an alterative embodiment, the pair of duct ports 196 and 198 are designed and spaced such that a minimal percentage of air pulled into the room came from the exhaust port.

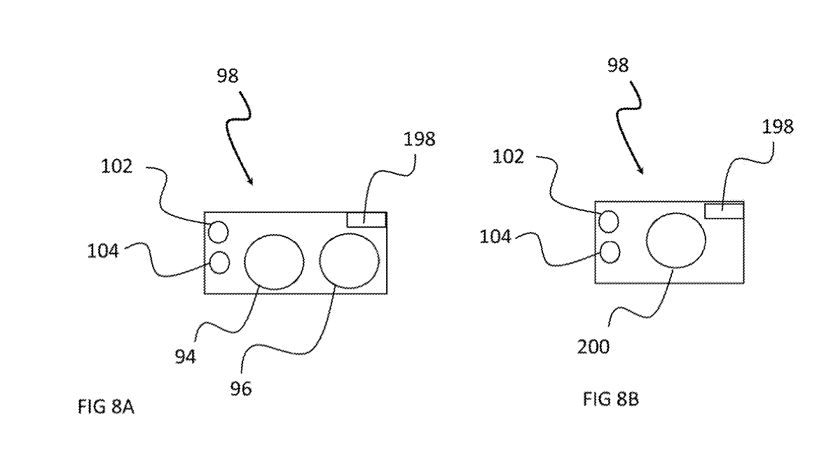

Referring to FIG. 8A, a sectional view of the conduit 98 is shown. The conduit 98 contains the air intake duct 94 and the air exhaust duct 96 which were shown in FIG. 2 and FIG. 7. In addition, the conduit 98 has a water input tube or pipe 104 for delivering water to the central unit 22 of the climate control system 20. The water is used to humidify the room and can also be used for fire suppress. In addition, there is a drain tube 102 which takes the water discharge or accumulation from the dehumidifier unit 62. The climate control system 20 is powered including the power unit 66 of the prime mechanical unit 50 as shown in FIG. 2, via a power cable raceway 198.

Referring to FIG. 8B, a sectional view of an alternative conduit 98 from the central unit 22 is shown. In contrast to an air intake duct 94 and an air exhaust duct 96 of the previous embodiment, there is only one duct 200. When the air conditioning unit 54 is in operation, the air that passes over the condensing coil 78 is drawn from the room 12 and exhausted through the duct 200. When air exchange is desired, the air purifier unit 64 draws stale air out during one time period and provides air from outside during another period.

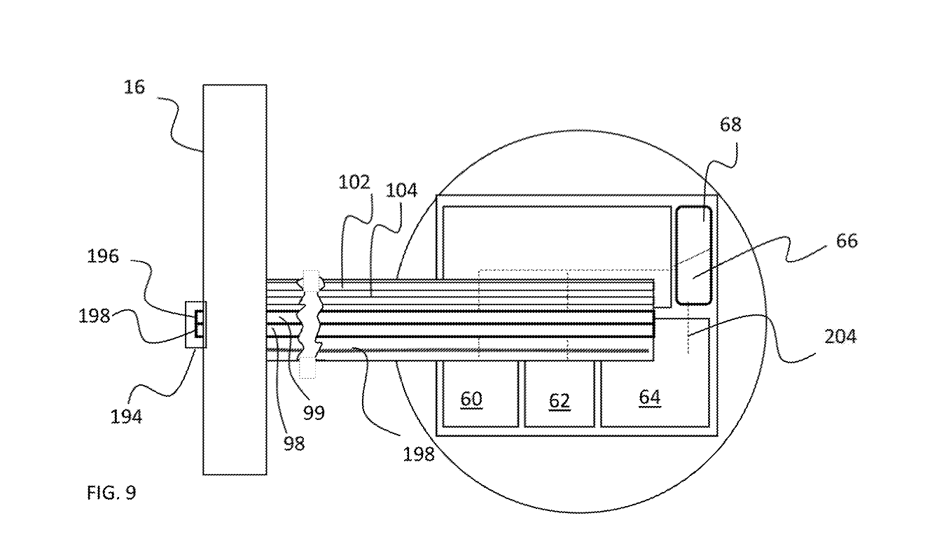

Referring to FIG. 9, a schematic view of the conduit 98 extending from the outside 18 to the prime mechanical unit 50 is shown. The air conditioning unit 43, the humidifier unit 60, the dehumidifier unit 62, and the air purifier unit 64 are shown. In addition, the power unit 66 and a central process unit 68 are also shown. Wiring 204 is schematically represented by dashed line. Wiring 204 for both power and data is run to each of the mechanical component units 52, the fan control, the motor 154, and the sensors.

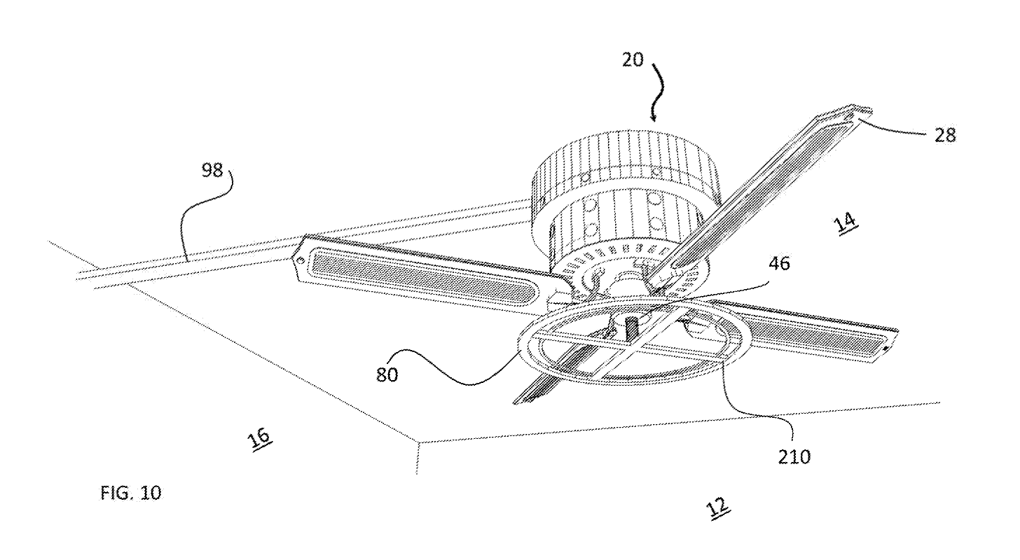

Referring to FIG. 10, a perspective view from below of an alternative embodiment of the climate control system with a circular heat element 80 underlying the central unit 22 and the inner edges of the fan blades 28 is shown. The circular heat element provides an additional element or elements to increase heat transfer while minimizing the temperature delta of a single element to the room 12 temperature.

Referring to FIG. 11, a schematic of sensor interaction is shown. The sensor unit 46 of the climate control system 20 has a plurality of sensors including the temperature sensor 48, the humidity sensor 112, and an air purity sensor 212, which are represented by a block in FIG. 11. If the climate control system 20 determines that the humidity is low as represented by block 216, the system 20 via one of the processing units such as the central processing unit 68 or the processor 108 in the humidifier unit 60, the fan is set to rotate so the air is pushed down in the center of the room and up at the edges as represented by circle 228. In addition, the climate control system 20 turns the valve 106 to allow the misters to produce mist as represented by block 240.

If the climate control system 20 determines that the humidity is high as represented by block 218, the system 20 via one of the processing unit such as the central processing unit 68, sets the fan to rotate so the air is drawn up in order to draw the air into the various openings 136 and 142 suctioning the humid air to the outside. The system 20 then brings fresh air from the outside. In addition, the climate control system 20 turns the dehumidifier unit 62 on to dry the air.

If the climate control system 20 determines that the air purity is low as by the air purity sensor 212 as represented by block 220, the system 20 via one of the processing units such as the central processing unit 68, turns the air purifier unit 64 which both exhaust stale air The system 20 uses the rotating fan blades 28 to pull the air up and in addition fans within the mechanical unit 50 to suction the low purity air to outside via the duct 96 in the conduit 98 as referenced by block 232 and block 242 and draw fresh air as referenced by block 234 and block 244.

If the climate control system 20 determines by the temperature sensor 38 that the temperature is low as represented by block 222, the system 20 either turns the heat on or turns air condition off dependent on the temperature. The fan blades 28 are rotated push the air down as represented by block 236.

If the climate control system 20 determines by the temperature sensor 38 that the temperature is how as represented by block 224, the system 20 either turns the heat off or turns air conditioning on dependent on the temperature. The fan rotates as represented by block 238.

If the climate control system 20 determines that the air purity is low as represented by block 220, the system 20 via one of the processing units such as the central processing unit 68, turns on the air purifier unit 64 which both exhaust stale air includes rotating the fan blades 28 and fans in the prime mechanical unit 50 as referenced by block 232 and block 242 and draws in fresh air as referenced by block 234 and block 244.

The fan is set to rotate so the air is drawn up in the center of the room and pushed down at the edges of the room 12 as represented by circle 230. In addition, the climate control system 20 turns the dehumidifier unit 62 on to dry the air. In addition, the system 20 forces air out of the room 12.

The climate control system 20 turns the valve 106 on to allow the misters to produce mist as represented by block 240.

The climate control system 20 has numerous features to save energy including energy lost along ducts by supplying the heat or cool air directly from the unit in the room—i.e. energy lost along extensive ducts in exiting models. In addition, energy is saved by the efficient use of sensors which activate the unit only when detecting movement in the vicinity.

The fan blade 28 of the climate control system saves energy by keeping the warm air from stagnating at the top of a room. Without the fan, the warmest air in a room rises, stagnating at the highest levels. The fan helps move the warm air downwards—adding further efficiency to the existing alternatives.

In addition to energy savings, there are potential space saving by increasing the availability of square footage by eliminating the need for various power units such as gas furnaces, as wells as the spaces required for ducts throughout a building or a house.

As indicated above, the climate control system contains all the elements to control the environment. In addition to air circulation, the climate control system can as well as serve as a fire sprinkler. As such it brings economies of scale for new construction where the cost and installation for separate projects for fire sprinklers piping, central air with extensive ducts. It also brings economies of scale by providing all-in-one air quality control such as humidity and air purity, as well as sensors for alarms. The sensors 46 can also include a smoke detector sensor and a high-temperature sensor which can and activate the sprinklers

### Equivalents

The invention may be embodied in other specific forms without departing from the spirit or essential characteristics thereof. The foregoing embodiments are therefore to be considered in all respects illustrative rather than limiting on the invention described herein. The true scope of the invention is thus indicated by the descriptions contained herein, as well as all changes that come within the meaning and ranges of equivalency thereof.

It is recognized that the humidifier unit 60 can also supply water as part of a fire suppression system. It is recognized that the climate control system 20 can have a sensor for fire and/or carbon dioxide.

It is recognized that there are various methods of achieving each of the functions described above. For example, there are numerous methods of dehumidifying the air including through a desiccant that absorbs moisture. The desiccant is heated to release the moisture. The system can use alternative methods of achieve the function.

It is recognized that a heating unit can be placed in the prime mechanical unit 50. It is also recognized that the air conditioning unit 54 can be tailored to be also a heating unit.

It is recognized that the climate control system 20 can have additional sensors such as to measure the level of carbon dioxide and trigger intake of fresh air and the removal of stale air. It is recognized that other air quality such as particle counting meter can be included.

It is recognized that while the house is used in describing the embodiment that the system can be used in other types of buildings.

What is claimed:

1. A climate control system adapted for a room having a ceiling, the climate control system comprising:
a central unit mounted to the ceiling, the central unit has a rotary portion;
a plurality of fan blades carried by the rotary portion, the fan blades adapted to direct air within the room by rotating clockwise and counter-clockwise;
a water line provide to the central unit; and
at least one nozzle carried by the central unit for generating mist from the water.

2. A climate control system of claim 1 wherein at least one of the fan blades has a heating element for producing heated air and the fan blades rotating for pushing heated air downward away from the ceiling.

3. A climate control system of claim 2 further comprising an air conditioning unit carried by the central unit, the system having a conduit extending from the central unit to a wall for routing at least one duct from the central unit for exhausting warm air from the air conditioning unit and a drain tube for draining water.

4. A climate control system of claim 2 further comprising a dehumidifier unit carried by the central unit, the system having a conduit extending from the central unit to a wall for routing a drain tube for draining water.

5. A climate control system of claim 2 further comprising an air purifier unit, the air purifier having a filter and an air exchange, the system having a conduit extending from the central unit to a wall for routing at least one duct from the central unit for air exchange.

6. A climate control system of claim 1 further comprising a sensor for monitoring air quality of the room.

7. A climate control system of claim 6 wherein the sensor from the group consisting of a fire sensor, a heat sensor, a smoke detection sensor, a temperature sensor, a humidity sensor, and an air quality sensor.

8. A climate control system of claim 1 further comprising a dehumidifier unit carried by the central unit, the system having a conduit extending from the central unit to a wall for routing a drain tube for draining water.

9. A climate control system of claim 1 further comprising a fire sensor wherein the nozzle can be used for fire suppression.

10. A climate control system adapted for a room having a ceiling, the climate control system comprising:
a central unit mounted to the ceiling, the central unit has a rotary portion;
a plurality of fan blades carried by the rotary portion, the fan blades adapted to direct air within the room by rotating clockwise and counter-clockwise; and
at least one of the fan blades has a heating element for producing heated air and the fan blades rotating for pushing heat downward away from the ceiling.

11. A climate control system of claim 10 further comprising a sensor for monitoring air quality of the room.

12. A climate control system of claim 11 further comprising a dehumidifier unit carried by the central unit, the system having a conduit extending from the central unit to a wall for routing a drain tube for draining water.

13. A climate control system of claim 12 wherein the dehumidifier has coils on the fan blades for dehumidifying the air as the fan blades rotate.

14. A climate control system of claim 13 wherein the fan blades have at least one flap that opens up to create more surface area.

15. A climate control system of claim 12 further comprising an air conditioning unit carried by the central unit, the system having a conduit extending from the central unit to a wall for routing at least one duct from the central unit for exhausting warm air from the air condition unit and a drain tube for draining water.

16. A climate control system of claim 12 further comprising an air purifier unit, the air purifier having a filter and an air exchange, the system having a conduit extending from the central unit to a wall for routing at least one duct from the central unit for air exchange.

17. A climate control system of claim 16 wherein the fan rotates to direct air as desired by the air purifier unit.

18. A climate control system of claim 12 further comprising a fire sensor wherein the nozzle can be used for fire suppression.

19. A climate control system of claim 10 further comprising a circular coil heat element underlying the circular unit.
